(19) United States
(12) Patent Application Publication
(10) Pub. No.: US 2026/0358262 A1
(43) Pub. Date: Nov. 12, 2026

(54) AMMONIA SENSOR

(71) Applicant: David PUTNAM, Sammamish, WA (US)

(72) Inventor: David PUTNAM, Sammamish, WA (US)

(21) Appl. No.: 19/488,025

(22) PCT Filed: Jun. 3, 2024
(86) PCT No.: PCT/US2024/032212

§ 371 Date: Nov. 25, 2025

Related U.S. Application Data
(60) Provisional application No. 63/505,878, filed on Jun. 2, 2023.

(51) Int. Cl. G01N 21/78; G01N 31/22

(52) U.S. Cl. CPC G01N 21/783; G01N 31/223

(57) ABSTRACT

The current document is directed to ammonia sensors and methods for detecting and measuring ammonia and to an ammonia monitoring system that incorporates the ammonia sensors to quantify excreted ammonia in a variety of different medical applications. The currently disclosed ammonia sensors produce a visually discernible color-change response signal that is concentration dependent and that reversibly responds to increases or decreases in the ammonia concentration. An ammonia sensor used in conjunction with an optical monitoring component can serve as an automated system to continuously measure the response signal, track and record ammonia-sensor response changes, and, when a high concentration of ammonia is indicated, output an alert or warning alarm.

### CROSS-REFERENCE TO RELATED APPLICATION

This application is a 371 of international PCT/US 2024/032212, filed Jun. 3, 2024, which claims the benefit of Provisional Application No. 63/505,878, file Jun. 2, 2023.

### TECHNICAL FIELD

The current document is directed to sensing the presence of ammonia gas excreted by humans and, in particular, to sensing excretion of ammonia by cutaneous respiration.

### BACKGROUND

The time-averaged concentration of ammonium ion and partial pressure of ammonia gas within the blood and tissues of a human are generally related to the human's metabolic health. Tests for the concentration of ammonium ions in blood are useful in the diagnosis of a variety of disease states. Conditions resulting in relatively high levels of ammonium ion and high partial pressures of ammonia with respect to average levels for humans can be damaging to body tissues and organs and a contributing factor in neurologic disorders. Ammonium-ion concentrations are frequently monitored by blood tests, but blood tests are invasive and do not provide for continuous and timely monitoring of ammonium-ion concentrations or the partial pressure of ammonia.

In water, blood, and other fluids, there is an equilibrium between ammonium ions, NH₄⁺, and ammonia gas NH₃. In the following discussion, the phrase “total ammonia” is used to refer to the total number of moles of ammonia and ammonium ions in a gaseous mixture, solution, or substance and the phrase “ammonia concentration” is used to refer to the total ammonia per volume or mass of a gaseous mixture, solution, or substance.

### SUMMARY

The current document is directed to ammonia sensors and methods that detect ammonia-concentration levels, estimate ammonia concentrations, and that, when incorporated into an ammonia monitoring system, estimates ammonia concentrations due to cutaneous respiration in a variety of different medical applications. The currently disclosed ammonia sensors produce a visually discernible color-change response signal that is concentration dependent and that reversibly responds to increases or decreases in the ammonia concentration. The ammonia sensors produce a baseline signal when not exposed to ammonia and when exposed to air with a very low concentration of ambient ammonia. In disclosed implementations, the baseline signal is a yellow color. As the ammonia concentration increases, the color changes from yellow to blue. Color-change responses by the ammonia sensors can be gauged by eye and quantified using a color-response gradient chart. The responses can also be measured using an optical instrument to interrogate the ammonia sensors and determine their color characteristics, which can then be correlated to known responses of the ammonia sensors to known ammonia concentrations in order to estimate the ammonia concentration in the environment surrounding the ammonia sensor. An ammonia sensor used in conjunction with an optical monitoring component can serve as an automated system to continuously measure the response signal, track and record ammonia-sensor response changes, and, when a high concentration of ammonia is indicated, output an alert or warning alarm. In certain applications, total ammonia within a human can be estimated from the measured response signal.

### BRIEF DESCRIPTION OF THE DRAWINGS

FIG. 1 illustrates a wearable ammonia sensor.

FIG. 2 illustrates an assembly of ammonia sensors on the liner or insole of a shoe or other footwear.

FIG. 3 illustrates yet another implementation of the currently claimed ammonia sensor used to monitor cutaneous respiration of ammonia transpiration from a user or patient.

FIG. 4 illustrates alternative implementations of the ammonia sensor with additional protective and barrier layers.

FIGS. 5A-C illustrate an implementation of the currently disclosed ammonia sensor that is reset to exhibit a baseline color by exposing the ammonia sensor to an ammonia adsorbent.

### DETAILED DESCRIPTION

The currently disclosed ammonia sensor uses an indicator dye which behaves like a pH indicator, exhibiting color changes that depend on the acidic or basic state of the environment to which the ammonia sensor is exposed. The ammonia sensor is constructed by incorporating the indicator into a solid carrier matrix so that the indicator is shielded from direct exposure to liquids. The sensory material created in this manner responds to exposure to gaseous acids or bases, such as ammonia, with a color change, in contrast to commonly used sensors that are immersed in an aqueous fluid to detect ammonium ions.

Ammonia and ammonium ions are by-products of metabolic activity within organisms, including humans, largely from catabolism of proteins, nucleic acids, and other nitrogen-containing compounds. The ammonia and ammonium ions circulating in human blood are converted, in the liver, into urea, which is a nontoxic compound that is excreted from the body in urine. Gaseous ammonia is excreted from the body directly through cutaneous respiration and exhaled during respiration, and both ammonia and ammonium ions are excreted in sweat, saliva and tears. Many complex biological processes contribute to maintaining a homeostatic balance of ammonia in organisms and to the removal of total ammonia from organisms. These processes can be perturbed and rendered dysfunctional by various disease states and by changes in metabolic functions. Since total ammonia is essentially toxic to cells and tissues at above normal concentrations, it is important to have a means of estimating and monitoring total ammonia in the human body in order to detect disorders that require medical attention. For example, in the case of individuals with renal dysfunction, who require dialysis to remove urea from their blood when their kidneys cannot, the physiological total ammonia can reach levels that result in the individuals smelling of ammonia. Occurrences of hyperammonemia can be caused by a variety of genetic abnormalities or acquired metabolic disorders, often related to enzyme defects, and high total ammonia levels can result in serious neurologic and life-threatening complications. Diabetic individuals suffering from diabetic foot neuropathy can exhibit greatly increased concentrations of ammonia near their feet. Extensive health complications can occur at a high frequency in the diabetic population. There is currently a lack of effective methods for diagnosing the severity of ammonia-related foot anomalies and thus a need for an approach that provides a warning signal indicating that treatment is necessary to preserve the foot.

The currently disclosed ammonia sensor non-invasively detects excretion of ammonia and provides estimates of deviations in total ammonia within organisms by sensing and monitoring ammonia. Certain of the currently disclosed devices and methods monitor ammonia concentrations proximal to an individual's feet. The currently disclosed ammonia sensor can also be used to detect and monitor ammonia proximal to other skin sites in conjunction related to various disease states. Ammonia sensors implemented in a wearable form enable a user to visually monitor the ammonia sensors' responses.

One implementation of the currently disclosed ammonia sensor is composed of a core ammonia sensor in a solid matrix form, an attachment mechanism or component that attaches the ammonia sensor either directly or proximally to a skin site, and one or more protective and barrier layers. The core ammonia-sensor material consists of ammonia-sensitive indicator dye molecules integrated into a solid carrier matrix, such as a thin hydrophobic polymeric film. Examples include polymeric films made from polytetrafluoroethylene (“PTFE”) and polyvinylidene fluoride (“PVDF”). Examples of indicator dyes include bromophenol blue (“BPB”), bromocresol green (“BCG”), bromocresol purple (“BCP”), and bromothymol blue (“BTB”). Certain manufacturing processes produce polymetric films and substrates that are optimally or near optimally suited for the ammonia-sensor application, including expansion processes for manufacturing PVDF and PTFE films and substrates. These processes render the product film or substrate capable of taking up the indicator dyes, so that the indicator dyes are incorporated into subsurface and/or interior portions of the product film or substrate and also render the product film or substrate permeable to gaseous ammonia. Electrospinning is another manufacturing process that provides suitable substrates and films.

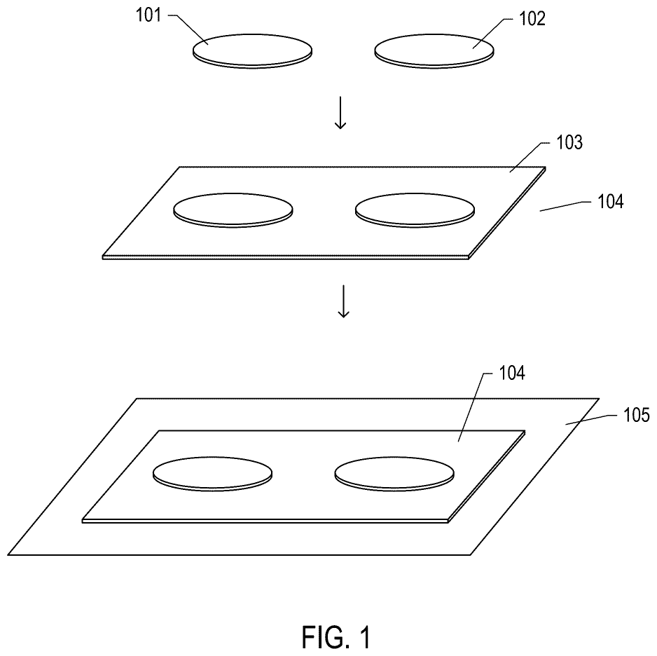

FIG. 1 illustrates a wearable ammonia sensor. Two sensor film disks 101 and 102, or core ammonia sensors, having different sensitivities to ammonia are shown at the top of FIG. 1. The sensor film disks are affixed to a barrier layer 103 to form an ammonia sensor 104. The ammonia sensor is then affixed to a liner or insole 105 of a shoe or other footwear. The sensor is held in place on the barrier 103 by an adhesive applied either to the bottom of the sensor film or by an adhesive applied to the barrier film. Another adhesive is coated on the side of the barrier that is in contact with the liner or insole 105.

The indicator dye is integrated on or within a solid matrix material in order to render the dye insoluble and physically manageable in a structural form that enables shaping, forming or cutting it into pieces to make core ammonia sensors 101 and 102. The indicator-dye-containing solid matrix material facilitates assembly of the core ammonia sensor with coverings and attachment of the ammonia sensors with adhesive agents or other attachment mechanisms or components to produce the wearable ammonia sensor 104.

Using a hydrophobic polymer as the solid matrix material has an advantage that the indicator molecules are shielded and protected from direct contact with liquids when the sensor is exposed to moisture and aqueous fluids such as urine and saliva. The hydrophobic polymer enables the sensor film to be immersed in body-fluids to enable measurement of the ammonia they contain. However, for those applications in which moisture and wetting fluids are not encountered, other types of matrixes may be used, such as paper and ceramics. Additionally, certain implementations of the currently disclosed ammonia sensor use matrixes which are not inherently hydrophobic. Indicators can be incorporated into a hydrophilic matrix that is treated or coated to render the resulting dye-incorporated matrix hydrophobic or water resistant. Plasma treatment is one example of a process that can be employed to render matrixes hydrophobic.

The ammonia-sensor matrix needs to enable gaseous ammonia to penetrate the matrix and interact with the dye indicator molecules. Films of PTFE and PVDF have this property of permeability to ammonia, as mentioned above. Expanded films of PTFE (“ePTFE”) are particularly effective. The matrix material can also be porous, with discrete channels or pores. Such properties can facilitate the passage of ammonia through the matrix to react with the dye molecules and promote faster ammonia-sensor-response times.

Thin films or membranes, especially porous fabrications of PVDF, have been found to be particularly effective because of their chemical resistance, temperature stability, and ability to be loaded with high concentrations of the indicator dyes and retain them stably over prolonged periods of immersion in water and other fluids. A wide variety of forms of PVDF can be used, including hydrophobic PVDF, hydrophilic PVDF, including PVDF membranes treated to alter the matrix surface, and porous membranes or filter products with 0.1-micron to 5-micron pores.

Certain commercially available PVDF thin films and filtration materials have thickness of 5 to 10 mils. They typically have sufficient physical robustness and rigidity to not need to be laminated or backed with another layer of material, such as polypropylene or polyester film, to give them the strength and support needed to enable practical handling, cutting, and manipulation by automated machinery for manufacturing ammonia-sensor devices. In contrast, ePTFE matrixes often include a laminated backing to facilitate processing.

In order to incorporate indicator dyes into a matrix, such as PVDF, selected solvents are used that solubilize the indicator dyes and that facilitate integration of the indicator dyes within the molecular structure of the polymer. Selected solvents include various alcohols and other polar solvents, such as ethanol, methanol, isopropyl alcohol, and dimethyl sulfoxide (“DMSO”). To create an ammonia sensor, the indicator dye is dissolved in solvent at a typical concentration of 5 mg/mL and the solution is applied to the matrix and allowed to penetrate the matrix. The application can be performed by immersing and bathing the matrix in the solution, using spray delivery, and by various printing techniques, including gravure printing and silk-screening. After the solvent is applied and incorporated into the matrix, the solvent is removed by drying and evaporation techniques. Depending upon the boiling-point and other characteristics of the solvent, this can be accomplished in ambient air or by heating and use of hot-air blowers.

After drying and evaporation of the solvent, the ammonia sensor may be rinsed, for example, by immersion in a water-bath, to remove residual traces of indicator dye that are not integrated/entrapped in the matrix and that, therefore, could subsequently leach from the matrix when the matrix is exposed to aqueous fluids, such as urine. Ammonia sensors not used in such environments may not need rinsing. Rinsing may also not be necessary when the indicator is fully incorporated into the matrix, as is often the case with PVDF matrixes.

Other approaches can be used to produce ammonia sensors that involve incorporating the indicator dyes directly into the raw polymer with or without the aid of a solvent. Solvents can be used to solubilize the indicator dyes and the bulk polymer and the admixture can then be used to fabricate thin film membranes by conventional techniques, such as casting and thermoforming of elastomeric polymer membranes. An alternative procedure, which does not use solvents, involves melting the polymer, dissolving the indicator dye or dyes into the polymer solution, and then directly fabricating thin films or membranes using extrusion or pressed-processing techniques. Alternatively, sensory fibers can be produced and subsequently fabricated into ammonia sensors, including fabric-based ammonia sensors and woven ammonia sensors. Another sensor fabrication approach involves solubilizing the indicator dye into a formulation of liquid PVDF. The liquid PVDF is then used for casting thin films or as a coating applied to other support materials. Additionally, fine filaments and fabric can be coated or printed using indicator-polymer-mixture inks. Ammonia sensors produced by the various methods described above can be formed into thin films that can be cut or formed into ammonia-sensor components which are used for sensing gaseous ammonia and ammonium-ion-containing solutions.

A wearable ammonia sensor 104 is produced by mounting one or more core ammonia sensors 101 and 102 to the top of a liner or insole of a shoe 105 in order to measure ammonia generated proximally to the foot. Additionally, a liner for a shoe or a sock may be manufactured to include an ammonia sensor to enable detecting different amounts of ammonia emitted from different portions of the bottom of the foot.

When the ammonia sensor, either in the form of a discrete ammonia sensor or an ammonia sensor incorporated into a shoe liner or sock, is deployed for measuring ammonia proximally to an individual's foot, there can be potential complications from ammonia that gets trapped within the shoe over time. In one implementation, this problem is addressed by placing a barrier material 103 that is impervious to ammonia between the ammonia sensor and the insole of the shoe. This prevents exposure of the sensor to residual ammonia, accumulated during prior use of the shoe, from diffusing outward, reaching the sensor, and perturbing the color-change response. The ammonia sensor thus responds only to ammonia newly emitted from the bottom of the foot.

In one implementation, the barrier material is a flexible plastic film that is optically transparent or transmissive to allow for the ammonia-sensor color-change response to be measured by an optical reader incorporated in a shoe while the shoe is worn. The optical reader incorporated into the footwear, in certain implementations, monitors the ammonia-sensor color-change response in real time through the optically transparent or transmissive barrier film interposed between the optical reader and the ammonia-sensor. When the ammonia-sensor is a small discrete component that can move or slip within the shoe during use, the ammonia-sensor may include an adhesive or mechanical coupling to fix the position of the ammonia-sensor. An adhesive that does not react with the ammonia-sensor and that does not interfere with optical interrogation can be applied directly to the side of the ammonia-sensor that faces the shoe. Alternatively, a laminating tape or double-sided adhesive can be used to fix the position of the ammonia-sensor. An advantage of this approach is that the film between the two layers of adhesive within a double-sided tape can constitute a barrier layer to protect the sensor from exposure to ammonia emanating from the shoe.

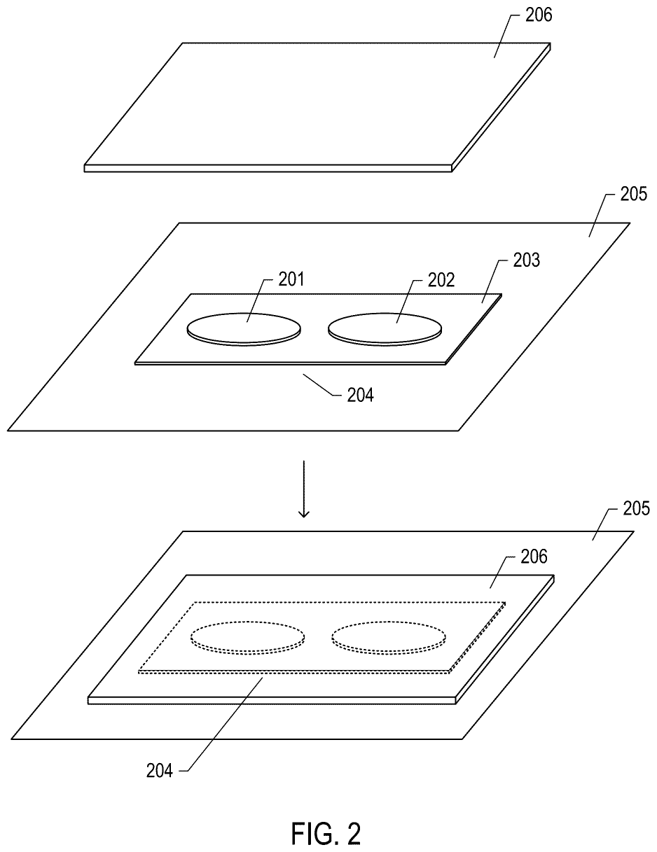

FIG. 2 illustrates an assembly of ammonia sensors on the liner or insole of a shoe or other footwear 205. The ammonia sensor 204 is positionally fixed by mounting a protective overcoat layer 206, such as a breathable adhesive film or tape or a thin, porous screen, including fine mesh metal wire, to provide a highly durable protection, over the top of the ammonia sensor, with borders of the tape extending past the periphery of the core ammonia sensors 201-202 and barrier material 203. The tape's adhesive binds and holds the ammonia sensor in place, and the portion of the adhesive beyond the edge of the ammonia sensor 204 serves to bind the ammonia sensor in place. There are many types of breathable films and tapes that allow the passage of ammonia and other gases from the foot to the ammonia sensor, including transparent or translucent breathable tapes. An example is the 3M product Transpore™. Such medical tapes are designed for safe skin-contact applications and provide for user-friendly application of peelable, replaceable, ammonia-sensor devices that can be preassembled as an integrated ammonia-sensor component, a barrier layer separating the ammonia sensor from a shoe, and adhesive that fixes the ammonia sensor in place within the shoe. Moreover, the breathable tape overcoat offers protection of the skin from direct contact with the ammonia sensor, protecting the sensor from physical abrasion and wear. This serves to reduce abrasion and damage of the sensors and keeps the sensors from directly contacting the foot.

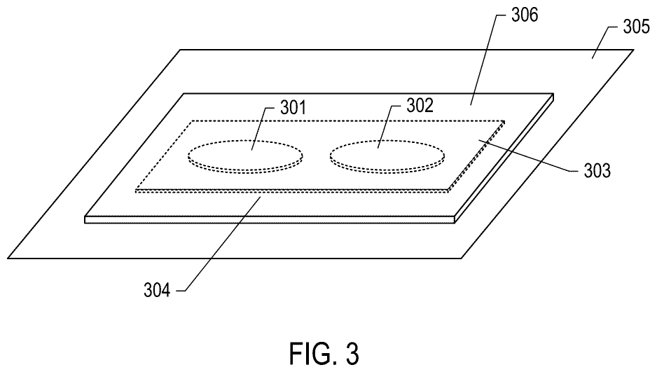

FIG. 3 illustrates yet another implementation of the currently claimed ammonia sensor used to monitor cutaneous respiration of ammonia transpiration from a user or patient. In this implementation, the ammonia sensor 304 comprising core ammonia sensors 301-302 and barrier 303 is attached to an individuals'skin 305 and viewable by the user or by instrumentation. In this case, the ammonia sensor does not have a gas-impermeable barrier interposed between the sensor and the skin to which it is attached. Instead, a gas-impermeable barrier 303 is mounted to the sides of the core ammonia sensors not facing the skin. Were the gas barrier not employed, and the sensor left open to the air, a portion of the ammonia emitted from the skin would escape into the air without contributing to the ammonia-sensor color-change response and environmental air would decrease the ammonia concentration further, additionally reducing the ammonia sensor's response. In certain cases, the gas barrier may not be needed. An optional protective-cover layer 306 may cover the ammonia sensor. As with the previously discussed ammonia sensor, the barrier layer that covers the wearable ammonia sensor needs to be optically transparent or transmissive. The optional protective-cover layer 306 provides physical protection of the ammonia sensor from external damage. In certain cases, a protective-cover layer that allows air exchange may allow for reversing the ammonia-sensor response, enabling changes in ammonia concentration to be monitored over time. An adhesive-tape covering can have the additional use of fixing the ammonia sensor in place.

In certain implementations a gas permeable protective layer or coating may be interposed between the ammonia sensor and the skin. The protective layer may be implemented by a breathable medical-grade tape. Protection can be alternatively provided by a spacer employed to physically offset the sensor from the skin to prevent direct contact between the ammonia sensor and skin. Additional protective-layer implementations include a thin film, secondary coatings, and post-processing treatments that are gas permeable. Examples include hydrophilic or hydrophobic thin films, such as a PTFE film, interposed between the ammonia sensor and the skin and an oleophobic material that is treated to repel oils, fats, detergents, and other nonaqueous compounds and that is applied to the ammonia sensor.

There are additional chemical treatments that can be applied to an ammonia sensor to impart improved hydrophobicity, hydrophilicity, and oleophobic properties, including plasma treatments. Ammonia sensors can be incorporated into wearables, including socks. Sensory fibers made from PVDF are rendered ammonia-sensitive by including an ammonia indicator into fibrils. The fibrils are then woven into a flexible fabric used to manufacture the sock. The sock responds to ammonia exuded from the foot and the user can observe the color change in the sock during the course of it being worn in a day. Alternatively, a sock can be manufactured to incorporate an ammonia sensor from PVDF, PTFE fibers, or other polymers, and the sock can then be treated with an ammonia indicator that is dissolved in a solvent for application to the sock. A third alternative is to use a solution of ammonia indicator solubilized with PVDF as a printable sensory ink or paint for coating the sock fabric or fibrils.

When the ammonia sensor includes a thin-film sensor material that is not itself physically sturdy or robust, a double-sided tape or laminating-tape can be used for attachment of the ammonia-sensor to a surface. Such double-sided adhesive-coated materials have an internal layer of plastic film, typically clear, sandwiched between the two adhesive layers. By affixing the ammonia-sensor to such tapes, the internal plastic component provides the strength and physical durability enabling the ammonia sensor to be mounted to the liner of a shoe and to other surfaces. The ammonia sensor can then be peeled-off and subsequently reapplied and removed multiple times.

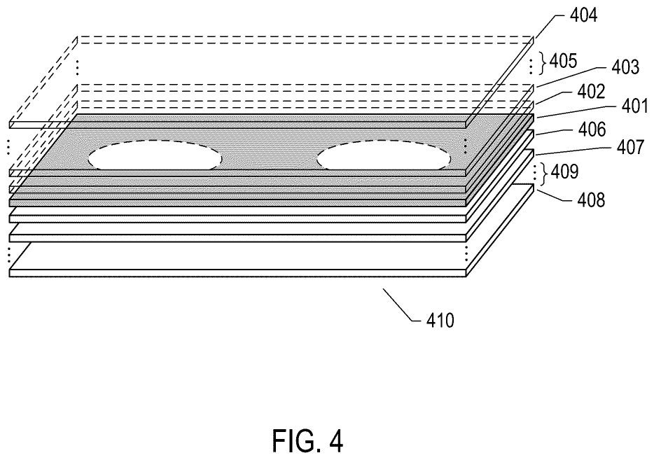

FIG. 4 illustrates alternative implementations of the ammonia sensor with additional protective and barrier layers. Various additional protective layers and barrier layers 402-404, with ellipsis 405 indicating the possibility of additional layers, may be included above the core ammonia sensors and substrate 401 and various additional protective layers and barrier layers 406-408, with ellipsis 409 indicating the possibility of additional layers, may be included below the core ammonia sensors and substrate 401 in alternative implementations of the currently disclosed ammonia sensor. The number of additional protective and barrier layers may vary from one to many. For example, when the environment of an ammonia sensor is known to contain additional types of volatile compounds that can interact with the indicator dye or dyes in the core ammonia sensors, a barrier or barriers that are impermeable to the additional types of volatile compounds but permeable to ammonia can be added to exclude the additional types of volatile compounds from interacting with the indicator dye or dyes in the core ammonia sensors. As another example, when the ammonia-concentration range in the local environment of the ammonia sensor is too broad, an additional barrier layer that is partially permeable to ammonia may be added to narrow the ammonia-concentration range in the local environment of the ammonia sensor.

Ammonia sensors can employ more than one type of indicator dye. For example, the BCG indicator has been found to provide for useful detection of relatively low ammonia concentrations. But foot ammonia levels can easily exceed such relatively low ammonia concentrations, so a different less sensitive indicator dye, such as BCP, can also be employed to provide meaningful responses at higher ammonia levels. Ammonia sensors that employ more than one indicator dye may incorporate the multiple indicator dyes in multiple layers. Multiple-indicator sensors may provide a wider measurement range than provided by single-indicator implementations. Another approach is to mix two or more different indicators together in order to fabricate a single combination-sensor material. For instance, BCG and BCP can be combined and produce a sensor layer that indicates ammonia concentrations over a broader range than when either indicator is used alone.

In most implementations, an optical path is required to lead from a surface of the ammonia sensor to the core ammonia sensor or sensors so that the color characteristics of the indicator dye or dyes within the core ammonia sensor or sensors and be interrogated by an optical reader or sensor or visually inspected by a user. This can be implemented by using an optically transparent or transmissive protective overcoat layer and optically transparent or transmissive additional protective and barrier layers between the protective overcoat layer and the core ammonia sensor or sensors or by providing aligned optically transparent or transmissive portions within the protective overcoat layer and additional protective and barrier layers between the protective overcoat layer and the core ammonia sensor or sensors.

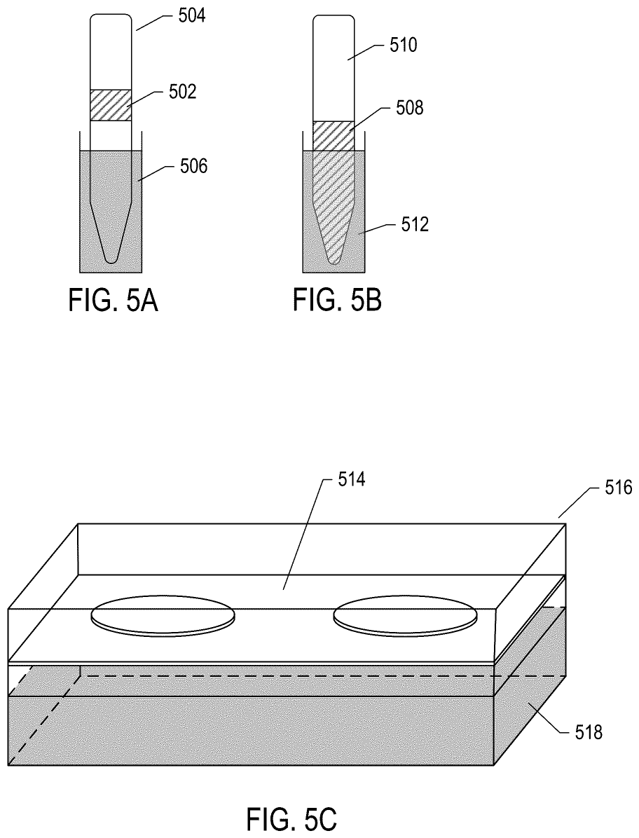

FIGS. 5A-C illustrate an implementation of the currently disclosed ammonia sensor that is reset to exhibit a baseline color by exposing the ammonia sensor to an ammonia adsorbent. In FIG. 5A, an ammonia sensor is shown in a basic configuration of use, consisting of a sensory element 502 attached to a supportive stick of plastic barrier material 504. In this case, the supportive stick has a region at the top which can be handled without touching the sensor element and a region at the bottom that sticks into an absorbent 506. The adsorbent scavenges the ammonia from the air around it. In this mode of use, the adsorbent apparatus extracts ammonia from the air, creating a low concentration gradient which results in ammonia being consequently extracted from the sensor. The adsorptive apparatus is usefully employed together with the above-described ammonia sensors, as illustrated in FIG. 5A. In one implementation, the adsorptive apparatus includes a container holding an ammonia-adsorbent compound into which the ammonia sensor is inserted. The adsorptive apparatus consists of an absorbent material 506 held in a vessel, tank, container, bottle, tube, or chamber. The containment device may include one or more closures or fitments to retain the adsorbent within the apparatus. The adsorbent creates an ammonia-free environment within the adsorptive apparatus. Examples of ammonia adsorbents include zeolite, diatomaceous earth, mineral clay compounds, and baking soda.

A procedure for using the adsorptive apparatus consists of placing the ammonia sensor material in the ammonia-free environment produced by the adsorptive apparatus by exposing the sensor to the air or headspace around the adsorbent, by placing the ammonia sensor in contact with the adsorbent, or by immersing or covering the sensor with the adsorbent. This process creates an ammonia concentration gradient between the ammonia sensor and the ammonia-free environment so that ammonia will be rapidly desorbed from the sensor and bound by the adsorbent.

The adsorptive apparatus provides several functions. The adsorptive apparatus provides storage for an ammonia sensor prior to use of the ammonia sensor. Additionally, after an ammonia sensor has been used, the adsorptive apparatus is used to quickly return the ammonia-sensor response to the baseline response. This active-extraction procedure works faster than allowing the ammonia-sensor response to reverse by the passive diffusion of ammonia from the sensor into ambient air.

An ammonia sensor can be placed into an adsorptive apparatus to measure or monitor the efficacy and capacity of the adsorptive apparatus to remove ammonia from the environment to which it is exposed. There are situations where ammonia in either a gas or liquid environment needs to be removed, which can be achieved by exposing and contacting the environment with an adsorbent in an adsorptive apparatus. Moreover, an ammonia sensor can be used to monitor the adsorptive capacity of the adsorbent itself. By tracking the ammonia in the adsorptive apparatus, an ammonia sensor can indicate when the adsorbent is losing its capacity to bind more ammonia and is effectively spent and therefore needs to be recharged or replaced.

FIG. 5B illustrates another implementation of the currently disclosed ammonia sensor. A sensor element 508 mounted on a supportive stick 510 is positioned in an adsorptive apparatus so that a portion of the sensor is immersed into, and in intimate contact with, the adsorbent 512. When the adsorbent is functionally active and effectively binding ammonia, the sensor region should not indicate that there is ammonia present, even though there may be ammonia detected by ammonia sensor material outside the adsorbent. However, when the adsorbent is no longer effective, the sensor portion indicates that free unbound ammonia is accumulating in the adsorbent and the sensor portion outside the adsorbent corroborates the presence of ammonia in the environment. As shown in FIG. 5C, the previously discussed ammonia sensor 514 can be place, alone or along with additional ammonia sensors, into a chamber 516 containing ammonia absorbent 518 prior to use for monitoring ammonia concentration, in order that the one or more ammonia sensors are set at a baseline response level when a next monitoring cycle begins.

Thus, one implementation of the currently disclosed ammonia sensor comprises: (1) an indicator dye or a mixture of two or more indicator dyes incorporated into one or more solid carrier matrixes to form one or more core ammonia sensors; (2) one or more protective and barrier layers; and (3) an optical path that provides for interrogation of the color characteristics of the indicator dye or mixture of two or more indicator dyes incorporated into one or more core ammonia sensors by an optical sensor or visual inspection of the of the indicator dye or mixture of two or more indicator dyes incorporated into one or more core ammonia sensors by a user. Many additional implementations are possible. For example, additional implementations may include additional types of protective and barrier layers, on either or both sides of the core ammonia sensors. Thus, although the present invention has been described in terms of particular embodiments, it is not intended that the invention be limited to these embodiments. Modifications within the spirit of the invention will be apparent to those skilled in the art. Additional implementations may include different types of indicator dyes and different mixtures of indicator dyes. Additional types of solid carrier matrixes can be used. When an ammonia sensor contains multiple core ammonia sensors, each of the multiple core sensors may contain indicator dyes or mixtures of indicator dyes that respond to different ammonia-concentration ranges. The multiple core ammonia sensors may be positioned at different depths within the sensor, in order to be differentially exposed to the local environment of the ammonia sensor. Different implementations may use different materials in order to exhibit different flexibilities, abrasion resistances, and other characteristics. Different implementations may have different shapes, sizes, and thicknesses.

1. An ammonia sensor comprising:
an indicator dye or a mixture of two or more indicator dyes incorporated into one or more solid carrier matrixes to form one or more core ammonia sensors;
one or more protective and barrier layers; and
an optical path that provides for interrogation of the color characteristics of the indicator dye or mixture of two or more indicator dyes incorporated into one or more core ammonia sensors by an optical sensor or visual inspection of the of the indicator dye or mixture of two or more indicator dyes incorporated into one or more core ammonia sensors by a user.

2. The ammonia sensor of claim 1 further including one or more of:
an attachment mechanism or attachment component that attaches the ammonia sensor to a surface; and
an ammonia-absorbent-containing vessel, tank, container, bottle, tube, or chamber into which the ammonia sensor is placed to desorb ammonia from the ammonia sensor, the ammonia absorbent selected from among ammonia absorbents that include zeolite, diatomaceous earth, mineral clay compounds, and baking soda.

3. The ammonia sensor of claim 1 wherein the one or more protective and barrier layers includes an ammonia impermeable barrier layer that prevents ammonia from diffusing from an external environment on one side of the ammonia sensor into the one or more core ammonia sensors.

4. The ammonia sensor of claim 1 where the ammonia impermeable barrier layer comprises one of:
a flexible plastic film;
a flexible plastic film that is optically transparent or transmissive;
a flexible plastic film that includes an optically transparent or transmissive portion that constitutes all or a portion of the optical path;
an adhesive tape;
an adhesive tape that is optically transparent or transmissive;
an adhesive tape that includes an optically transparent or transmissive portion that constitutes all or a portion of the optical path;
a double-sided adhesive tape;
a double-sided adhesive tape that is optically transparent or transmissive;
a double-sided adhesive tape that includes an optically transparent or transmissive portion that constitutes all or a portion of the optical path;
a laminating tape;
a laminating tape that is optically transparent or transmissive; and
a laminating tape that includes an optically transparent or transmissive portion that constitutes all or a portion of the optical path.

5. The ammonia sensor of claim 3 wherein the one or more protective and barrier layers includes additional layers, the additional layers including:
a gas permeable film, including one of a hydrophilic or hydrophobic film, such as a hydrophobic PTFE film, and an oleophobic material;
a gas permeable coating; and
one or more gas permeable post-processing treatments, including plasma treatments.

6. The ammonia sensor of claim 1 wherein the one or more protective and barrier layers includes a protective overcoat layer covering the top of the ammonia sensor.

7. The ammonia sensor of claim 6 wherein the protective overcoat layer is one of:
a breathable plastic or polymer film or tape;
a porous screen;
a metal wire mesh.

8. The ammonia sensor of claim 6 wherein the protective overcoat layer includes an adhesive that attaches the protective overcoat layer to another protective or barrier layer between the protective overcoat layer and the one or more core ammonia sensors or directly to the one or more core ammonia sensors.

9. The ammonia sensor of claim 6 wherein the protective overcoat layer has borders extending past the peripheries of the one or more core ammonia sensors and any intervening additional protective and barrier layers.

10. The ammonia sensor of claim 9 wherein the protective overcoat layer includes an adhesive that both attaches the protective overcoat layer to another protective or barrier layer between the protective overcoat layer and the one or more core ammonia sensors or to the one or more core ammonia sensors and additionally attaches the protective overcoat layer to another protective or barrier layer between the one or more core ammonia sensors and a surface to which the ammonia sensor is affixed or directly to the surface to which the ammonia sensor is affixed.

11. The ammonia sensor of claim 6 wherein the protective overcoat layer is optically transparent or transmissive or includes an optically transparent or transmissive portion that constitutes all or a portion of the optical path.

12. The ammonia sensor of claim 1 wherein the one or more core ammonia sensors comprises films, substrates, or threads that incorporate indicator dyes into subsurface and/or interior portions of the one or more core ammonia sensors and that are permeable to gaseous ammonia.

13. The ammonia sensor of claim 12 wherein the core ammonia sensors are composed of hydrophobic polymers, including:
polytetrafluoroethylene (“PTFE”);
expanded PTFE;
electrospun PTFE;
polyvinylidene fluoride (“PVDF”);
expanded PVDF; and
electrospun PVDF.

14. The ammonia sensor of claim 1 wherein the core ammonia sensors are composed of one of
paper;
a ceramic; and
a hydrophilic matrix that is treated or coated to render the resulting dye-incorporated matrix hydrophobic or water resistant.

15. The ammonia sensor of claim 14 wherein a plasma treatment is used to render the hydrophilic matrix hydrophobic.

16. The ammonia sensor of claim 1 wherein the indicator dye or mixture of two or more indicator dyes exhibit a color-change response that is concentration-dependent and that is reversibly responsive to increases or decreases in the ammonia concentration, the indicator dye or mixture of two or more indicator dyes exhibiting a baseline color when not exposed to ammonia and when exposed to air with a very low concentration of ambient ammonia.

17. The ammonia sensor of claim 16 wherein the indicator dyes include bromophenol blue (“BPB”), bromocresol green (“BCG”), bromocresol purple (“BCP”), and bromothymol blue (“BTB”).

18. The ammonia sensor of claim 1 wherein each solid carrier matrix of two or more core ammonia sensors in the ammonia sensor contains a different indicator dye or a different mixture of two or more indicator dyes.

19. The ammonia sensor of claim 1 that is attached to a liner or insole within a shoe to form a wearable ammonia sensor.

20. The ammonia sensor of claim 1 that is incorporated into a sock to form a wearable ammonia sensor.

21. The ammonia sensor of claim 1 that is attached to the skin of a human patient or user.
